(19) United States
(12) Patent Application Publication
(10) Pub. No.: US 2013/0034734 A1
(43) Pub. Date: Feb. 7, 2013

(54) RESIN COMPOSITION AND COMPOSITE MADE BY SAME

(71) Applicants: HSIN-PEI CHANG, Tu-Cheng (TW); JUN-YI WANG, Shenzhen City (CN); XUE-PENG LI, Shenzhen City (CN); MING-HSU LU, Tu-Cheng (TW); LIANG-LIANG DONG, Shenzhen City (CN)

(72) Inventors: HSIN-PEI CHANG, Tu-Cheng (TW); JUN-YI WANG, Shenzhen City (CN); XUE-PENG LI, Shenzhen City (CN); MING-HSU LU, Tu-Cheng (TW); LIANG-LIANG DONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/327,506

(22) Filed: Dec. 15, 2011

(30) Foreign Application Priority Data
Aug. 5, 2011 (CN) 201110224406.4

(51) Int. Cl. B32B 5/08; C08K 7/14; C08L 69/00; C08L 67/00; B32B 15/08; C08L 51/06; C08L 53/00; C08L 25/06; C08L 55/02; C08L 53/02; C08L 67/02; C08L 33/08

(52) U.S. Cl. 428/412; 524/605; 524/537; 524/539; 524/513; 524/504; 524/505; 428/461; 428/458

(57) ABSTRACT

A resin composition used to being injection molded to metal to make composite of resin and metal, comprises 40% to 90% by weight of main resin, 0% to 30% by weight of reinforcer; and 0% to 40% by weight of filler. The main resin comprises one or more ingredients selected from a group consisting of PCT and derivatives of PCT. The resin composition has a low crystallization temperature and an appropriate crystallization rate.

### CROSS-REFERENCE TO RELATED APPLICATIONS

This application is one of the three related co-pending U.S. patent applications listed below. All listed applications have the same assignee. The disclosure of each of the listed applications is incorporated by reference into all the other listed applications.

| Attorney | | |
|---|---|---|
| Docket No. | Title | Inventors |
| US 40743 | RESIN COMPOSITION AND | HSIN-PEI CHANG |
| | COMPOSITE MADE BY SAME | et al. |
| US 41138 | RESIN COMPOSITION AND | HSIN-PEI CHANG |
| | COMPOSITE MADE BY SAME | et al. |
| US 41139 | RESIN COMPOSITION AND | HSIN-PEI CHANG |
| | COMPOSITE MADE BY SAME | et al. |

### BACKGROUND

1. Technical Field

The present disclosure relates to a resin composition and composites of resin and metal made by the resin composition.

2. Description of Related Art

To make a composite of metal and resin, a metal is first surface treated to form recesses on its surface. Then a thermoplastic resin composition is injected to the treated metal surface by injection molding and integrally bonds to the metal. The thermoplastic resin composition often contains polyphenylene sulfide (PPS) or polybutylene terephthalate (PBT) as a main component.

However, PPS resin composition can decompose into sulfurous acid during the molding process, which damages the injection molding machine. Also, during the molding process, molten PBT resin composition usually crystallizes before it fills the recesses of the metal due to its high crystallization rate, which makes a weak bond between resin and metal.

Therefore, there is room for improvement within the art.

### DETAILED DESCRIPTION

The resin composition is used to make the composite of metal and resin, includes a main resin, a reinforcer and a filler. The mass percentage of the main resin is about 40% to 90%, the mass percentage of the reinforcer is about 0% to 30%, and the mass percentage of the filler is about 0% to 40%.

The main resin comprises one or more ingredients selected from a group consisting of poly (1, 4-cyclohexylene dimethylene terephthalate) (PCT) and derivatives of PCT.

The derivative of PCT may be glycol-modified poly (1, 4-cyclohexylene dimethylene terephthalate) (PCTG) or acid-modified poly (1, 4-cyclohexylene dimethylene terephthalate) (PCTA).

The reinforcer comprises one or more ingredients selected from a group consisting of polyester, ethylene copolymers, styrene polymers, thermoplastic polyamide elastomers, and derivatives of thermoplastic polyamide elastomers. The reinforcer can reinforce the resin composition and strengthen the bond between metal and resin.

The polyester comprises one or more ingredients selected from a group consisting of polycarbonate (PC), derivatives of PC, thermoplastic polyester elastomers (TPEE), and derivatives of TPEE.

The ethylene copolymer is copolymers of ethylene monomer and other monomers, wherein the other monomer is one selected from a group consisting of α-olefin, non-conjugated diene, vinyl acetate, α, β-unsaturated carboxylic acid, and derivatives of α, β-unsaturated carboxylic acid. Ethylene-ethyl acrylate (EEA) is preferable.

The styrene polymer comprises one or more ingredients selected from a group consisting of polystyrene (PS), graft-modified PS, acrylonitrile-butadient-styrene (ABS), graft-modified ABS, styrene-butadiene-styrene (SBS), graft-modified SBS, styrene-ethylene/butylene-styrene (SEBS), and graft-modified SEBS.

The filler enhances the strength of the resin composition and reduces the linear expansion coefficient of the resin composition, making the value of linear expansion coefficient of the metal closer to that of the resin composition. The filler comprises at least one ingredient selected from a group consisting of glass fiber, carbon fiber, aramid fiber, calcium carbonate, magnesium carbonate, titanium dioxide, silica, talc, clay, and glass powder.

The resin composition may be directly molded to the treated surface of the metal by injection molding to form a composite of metal and resin. The metal may be made of aluminum alloy, titanium alloy, copper alloy, magnesium alloy or steel alloy. The metal has an ultra-fine irregular surface after being surface treated. The bond between the metal and the resin composition is substantially stronger when the metal has a plurality of recesses with diameter of about 10 nm to 1 μm on the surface.

### EXAMPLE

A resin composition 10 was prepared. The resin composition 10 included 60 wt % of PCT, 10 wt % of EEA, and 30 wt % of glass fiber.

For comparison, another resin composition 20 was provided. The resin composition 20 included 70 wt % of PCT and 30 wt % of glass fiber.

The resin composition 10 and resin composition 20 were molded to the same aluminum plate by injection molding to form a composite A and a composite B, respectively. The aluminum plate had been surface treated. Both the composite A and the composite B were annealed at 120° C. for 1 hour. Then the shearing strength between the aluminum plate and the resin composition 10 and 20 were tested. Shearing strength between the resin composition 10 and the aluminum plate was 26 MPa, and shearing strength between the resin composition 20 and the aluminum plate was 20 MPa. Thus, the bond between the resin composition 10 and the metal was substantially stronger than the bond between the resin composition 20 and the metal.

The resin composition in this disclosure has a low crystallization temperature and appropriate crystallization rate. The bond between the resin composition and metal is strong. The resin composition contains no sulfur and does not damage the mold.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

1. A resin composition, comprising:
about 40% to 90% by weight of a main resin, the main resin comprising one or more ingredients selected from a group consisting of poly (1, 4-cyclohexylene dimethylene terephthalate) and derivatives of poly (1, 4-cyclohexylene dimethylene terephthalate);
about 0% to 30% by weight of a reinforcer; and
about 0% to 40% by weight of a filler.

2. The resin composition as claimed in claim 1, wherein derivative of poly (1, 4-cyclohexylene dimethylene terephthalate) is glycol-modified poly (1, 4-cyclohexylene dimethylene terephthalate) or acid-modified poly (1, 4-cyclohexylene dimethylene terephthalate).

3. The resin composition as claimed in claim 1, wherein the filler comprises at least one selected from a group consisting of glass fiber, carbon fiber, aramid fiber, calcium carbonate, magnesium carbonate, titanium dioxide, silica, talc, clay, and glass powder.

4. The resin composition as claimed in claim 1, wherein the reinforcer comprises one or more ingredients selected from a group consisting of polyester, ethylene copolymers, styrene polymers, thermoplastic polyamide elastomers and derivatives of thermoplastic polyamide elastomers.

5. The resin composition as claimed in claim 4, wherein the polyester comprises one or more ingredients selected from a group consisting of polycarbonate, derivatives of polycarbonate, thermoplastic polyester elastomers, and derivatives of thermoplastic polyester elastomers.

6. The resin composition as claimed in claim 4, wherein the ethylene copolymer comprises one or more ingredients selected from a group consisting of copolymers of ethylene monomer and α-olefin monomer, copolymers of ethylene monomer and non-conjugated diene monomer, copolymers of ethylene monomer and vinyl acetate monomer, copolymers of ethylene monomer and α, β-unsaturated carboxylic acid monomer, and copolymers of ethylene monomer and derivatives monomer of α, β-unsaturated carboxylic acid.

7. The resin composition as claimed in claim 4, wherein the styrene polymer comprises one or more ingredients selected from a group consisting of polystyrene, acrylonitrile butadient styrene, styrene-butadiene-styrene, and styrene-ethylene/butylene-styrene.

8. A composite of metal and resin, comprising:
a metal substrate, and
a resin object formed on the metal substrate by injection molding, the resin object being formed of a resin composition,
wherein the resin composition comprises:
about 40% to 90% by weight of a main resin, the main resin comprising one or more ingredients selected from a group consisting of poly (1, 4-cyclohexylene dimethylene terephthalate) and derivatives of poly (1, 4-cyclohexylene dimethylene terephthalate);
about 0% to 30% by weight of a reinforcer; and
about 0% to 40% by weight of a filler.

9. The composite of metal and resin as claimed in claim 8, wherein the metal substrate is made of aluminum alloy, titanium alloy, copper alloy, magnesium alloy or steel alloy.

10. The composite of metal and resin as claimed in claim 8, wherein there is a plurality of recesses on the surface of the metal substrate, the recesses having diameters of about 10 nm to 1 μm.

11. The composite of metal and resin as claimed in claim 8, wherein the filler comprises at least one selected from a group consisting of glass fiber, carbon fiber, aramid fiber, calcium carbonate, magnesium carbonate, titanium dioxide, silica, talc, clay, and glass powder.

12. The composite of metal and resin as claimed in claim 8, wherein the reinforcer comprises one or more ingredients selected from a group consisting of polyester, ethylene copolymers, styrene polymers, thermoplastic polyamide elastomers, and derivatives of thermoplastic polyamide elastomers.

13. The composite of metal and resin as claimed in claim 12, wherein the polyester comprises one or more ingredients selected from a group consisting of polycarbonate, derivatives of polycarbonate, thermoplastic polyester elastomers, and derivatives of thermoplastic polyester elastomers.

14. The composite of metal and resin as claimed in claim 12, wherein the ethylene copolymer comprises one or more ingredients selected from a group consisting of copolymers of ethylene monomer and α-olefin monomer, copolymers of ethylene monomer and non-conjugated diene monomer, copolymers of ethylene monomer and vinyl acetate monomer, copolymers of ethylene monomer and α, β-unsaturated carboxylic acid monomer, and copolymers of ethylene monomer and derivatives monomer of α, β-unsaturated carboxylic acid.

15. The composite of metal and resin as claimed in claim 12, wherein the styrene polymer comprises one or more ingredients selected from a group consisting of polystyrene, acrylonitrile butadient styrene, styrene-butadiene-styrene, and styrene-ethylene/butylene-styrene.
